(19) United States
(12) Patent Application Publication
(10) Pub. No.: US 2002/0009406 A1
(43) Pub. Date: Jan. 24, 2002

(54) Chromium-rare earth based catalysts and process for converting hydrocarbons to synthesis gas

(76) Inventors: Kostantinos Kourtakis, Swedesboro, NJ (US); Anne M. Gaffney, West Chester, PA (US); Lin Wang, Wilmington, DE (US)

Correspondence Address: Joanna K. Payne, CONOCO INC., 1000 South Pine Street 2635 RW, P.O. Box 1267, Ponca City, OK, 74602-1267, US

(21) Appl. No.: 09/785,354

(22) Filed: Feb. 16, 2001

Related U.S. Application Data
(60) Provisional application No. 60/183,575, filed on Feb. 18, 2000.

(51) Int. Cl. C01B 3/26; C01B 31/18; B01J 23/10

(52) U.S. Cl. 423/418.2; 502/302; 502/303; 502/304; 423/651

(57) ABSTRACT

Catalysts and processes for the catalytic conversion of hydrocarbons to carbon monoxide and hydrogen employing new families of chromium-rare earth based catalysts are disclosed. One highly active and selective catalyst system, providing greater than 95% CH₄ conversion, and 97-98% selectivity to CO and H₂ by a net catalytic partial oxidation reaction, is a Ce—Cr—Ni containing compound. A preferred process for the catalytic conversion of a hydrocarbon comprises contacting a feed stream comprising a methane-containing hydrocarbon feedstock and an oxygen-containing gas with a chromium-rare earth containing catalyst in a short contact time reactor maintained at partial oxidation promoting conditions effective to produce synthesis gas.

### CROSS-REFERENCE TO RELATED APPLICATIONS

This application claims the benefit under 35 U.S.C. 119(e) of U.S. Provisional Application No. 60/183,575 filed Feb. 18, 2000. This application is also related to U.S. Provisional Application No. 60/183,423 filed Feb. 18, 2000, which corresponds to copending U.S. Non-Provisional Patent Application No. ______ filed ______.

### BACKGROUND OF THE INVENTION

1. Field of the Invention

The present invention relates to catalysts and processes for the catalytic conversion of hydrocarbons (e.g., natural gas) using chromium-rare earth based catalysts to produce carbon monoxide and hydrogen (synthesis gas). More particularly, the invention relates to such catalysts and their manner of making, and to processes employing the catalysts for production of synthesis gas.

2. Description of Related Art

Large quantities of methane, the main component of natural gas, are available in many areas of the world, and natural gas is predicted to outlast oil reserves by a significant margin. However, most natural gas is situated in areas that are geographically remote from population and industrial centers. The costs of compression, transportation, and storage make its use economically unattractive.

To improve the economics of natural gas use, much research has focused on methane as a starting material for the production of higher hydrocarbons and hydrocarbon liquids. The conversion of methane to hydrocarbons is typically carried out in two steps. In the first step, methane is reformed with water to produce carbon monoxide and hydrogen (i.e., synthesis gas or “syngas”). In a second step, the syngas is converted to hydrocarbons, for example, using the Fischer-Tropsch process to provide fuels that boil in the middle distillate range, such as kerosene and diesel fuel, and hydrocarbon waxes.

Current industrial use of methane as a chemical feedstock proceeds by the initial conversion of methane to carbon monoxide and hydrogen by either steam reforming, which is the most widespread process, or by dry reforming. Steam reforming currently is the major process used commercially for the conversion of methane to synthesis gas, proceeding according to Equation 1.

CH₄+H₂O [symbol] CO+3H₂ (1)

Although steam reforming has been practiced for over five decades, efforts to improve the energy efficiency and reduce the capital investment required for this technology continue.

The catalytic partial oxidation of hydrocarbons, e.g., natural gas or methane to syngas is also a process known in the art. While currently limited as an industrial process, partial oxidation has recently attracted much attention due to significant inherent advantages, such as the fact that significant heat is released during the process, in contrast to steam reforming processes.

In catalytic partial oxidation, natural gas is mixed with air, oxygen-enriched air, or oxygen, and introduced to a catalyst at elevated temperature and pressure. The partial oxidation of methane yields a syngas mixture with a H₂:CO ratio of 2:1, as shown in Equation 2.

CH₄+½O₂ [symbol] CO+2H₂ (2)

This ratio is more useful than the H₂:CO ratio from steam reforming for the downstream conversion of the syngas to chemicals such as methanol and to fuels. The partial oxidation is also exothermic, while the steam reforming reaction is strongly endothermic. Furthermore, oxidation reactions are typically much faster than reforming reactions. This allows the use of much smaller reactors for catalytic partial oxidation processes. The syngas in turn may be converted to hydrocarbon products, for example, fuels boiling in the middle distillate range, such as kerosene and diesel fuel, and hydrocarbon waxes by processes such as the Fischer-Tropsch Synthesis.

The selectivities of catalytic partial oxidation to the desired products, carbon monoxide and hydrogen, are controlled by several factors, but one of the most important of these factors is the choice of catalyst composition. Difficulties have arisen in the prior art in making such a choice economical. Typically, catalyst compositions have included precious metals and/or rare earths. The large volumes of expensive catalysts needed by prior art catalytic partial oxidation processes have placed these processes generally outside the limits of economic justification.

For successful operation at commercial scale, the catalytic partial oxidation process must be able to achieve a high conversion of the methane feedstock at high gas hourly space velocities, and the selectivity of the process to the desired products of carbon monoxide and hydrogen must be high. Such high conversion and selectivity must be achieved without detrimental effects to the catalyst, such as the formation of carbon deposits (“coke”) on the catalyst, which severely reduces catalyst performance. Accordingly, substantial effort has been devoted in the art to the development of catalysts allowing commercial performance without coke formation.

A number of process regimes have been described in the art for the production of syngas via catalyzed partial oxidation reactions. The noble metals, which typically serve as the best catalysts for the partial oxidation of methane, are scarce and expensive. The widely used, less expensive, nickel-based catalysts have the disadvantage of promoting coke formation on the catalyst during the reaction, which results in loss of catalytic activity.

U.S. Pat. No. 5,149,516 discloses a process for the partial oxidation of methane comprising contacting methane and a source of oxygen with a perovskite of the formula ABO₃, where B can be a variety of metals including Cr. In the example shown, the perovskite that was used is LaCoO₃. M. Stojanovic et al., (J. Catal. (1997) 166 (2), 324-332) disclose the use of chromium-containing ternary perovskite oxides, LaCr₁₋ₓNiₓO₃ (x=0 to 1.0) as catalysts for the partial oxidation of methane to syngas. The catalytic activity was found to increase monotonically with the value of x, i.e., LaCrO₃ was found to be the least active catalyst.

U.S. Pat. No. 5,447,705 also discloses a process for the partial oxidation of methane to syngas by contacting the starting materials with a catalyst having a perovskite crystalline structure and having the composition LnₓA_{1-y}B_{y}O₃, in which x is a number such that 0<x<10, y is a number such that 0<y<1, Ln is at least one of a rare earth, strontium or bismuth, A is a metal of groups IVb, Vb, VIb, VIIb or VIII, A is a metal of groups IVb, Vb, VIb, VIIb or VIII and A and B are two different metals. Various combinations of La, Ni and Fe were exemplified.

U.S. Pat. No. 5,149,464 discloses a method for selectively converting methane to syngas at 650° C. to 950° C. by contacting the methane/oxygen mixture with a solid catalyst, which is either: (a) a catalyst of the formula MₓM′_{y}O_{z} where: M is at least one element selected from Mg, B, Al, Ln, Ga, Si, Ti, Zr and Hf; Ln is at least one member of lanthanum and the lanthanide series of elements, M′ is a d-block transition metal, and each of the ratios x/z and y/z and (x+y)/z is independently from 0.1 to 8; or (b) an oxide of a d-block transition metal; or (c) a d-block transition metal on a refractory support; or (d) a catalyst formed by heating a) or b) under the conditions of the reaction or under non-oxidizing conditions. The d-block transition metals are selected from those having atomic number 21 to 29, 40 to 47 and 72 to 79, the metals Sc, Ti, Va, Cr, Mn, Fe, Co, Ni, Cu, Zr, Nb, Mo, Tc, Ru, Rh, Pa, Ag, Hf, Ta, W, Re, Os, Ir, Pt and Au. Preferably M′ is selected from Fe, Os, Co, Rh, Ir, Pd, Pt and particularly Ni and Ru.

U.S. Pat. No. 5,431,855 describes a catalyst which catalyzes the combined partial oxidation-dry reforming reaction of a reactant gas mixture comprising CO₂, O₂ and CH₄ to for a product gas mixture comprising CO and H₂. Related patent U.S. Pat. No. 5,500,149 describes similar catalysts and methods for production of product gas mixtures comprising H₂ and CO.

U.S. Pat. No. 2,942,958 discloses an improved method for converting methane to carbon monoxide and hydrogen employing a reforming catalyst for the steam-methane reaction. Although it is stated that any reforming catalyst is suitable for the process, the preferred catalysts are nickel, chromium and cobalt, or their oxides.

An example of the previous attempts at synthesis gas production by catalytic partial oxidation to overcome some of the disadvantages and costs of steam reforming are described in EP303438 entitled “Production of Methanol from Hydrocarbonaceous Feedstock.” The asserted advantages of EP303438 are relatively independent of catalyst composition, i.e., “partial oxidation reactions will be mass transfer controlled. Consequently, the reaction rate is relatively independent of catalyst activity, but dependent on surface area-to-volume ratio of the catalyst.” A monolith catalyst is used with or without metal addition to the surface of the monolith at space velocities of 20,000-500,000 hr⁻¹. The suggested metal coatings of the monolith are selected from the exemplary list of palladium, platinum, rhodium, iridium, osmium, ruthenium, nickel, chromium, cobalt, cerium, lanthanum, and mixtures thereof in addition to metals of the groups IA, IIA, III, IV, VB, VIB, or VIIB. An exemplary catalyst comprises alumina on cordierite, with a coating comprising platinum and palladium. Steam is required in the feed mixture to suppress coke formation on the catalyst. Products from the partial oxidation of methane employing these catalysts results in the production of significant quantities of carbon dioxide, steam, and C₂+ hydrocarbons.

None of the prior art processes or catalysts describes a completely satisfactory catalyst or process capable of high conversion and high selectivity for CO and H₂ products and which are capable of operation with very low coke formation. Accordingly, there remains a need for a process and catalyst for converting hydrocarbons, particularly methane, that have low coke formation, high conversions of methane and high selectivities to CO and H₂, and which are economically feasible at commercial-scale conditions.

### SUMMARY OF THE INVENTION

Many of the shortcomings of conventional syngas manufacturing methods are overcome by the processes and catalysts of the present invention. The preferred chromium-based catalysts provide high levels of activity (i.e., conversion of CH₄) and higher selectivity to CO and H₂ reaction products than is typically available with conventional catalytic systems designed for commercial-scale use. Another advantage of the catalytic compositions and syngas production processes of the invention is that no appreciable coking occurs with use of many of the chromium-containing catalyst compositions, in particular the rare-earth containing compositions. Still another advantage of the new catalysts and processes is that they are more economically feasible for use in commercial-scale conditions than conventional catalysts now used for producing syngas. Some catalyst compositions containing higher-melting-point pure ceramic oxides instead of metals, demonstrate improved catalyst life when used for production of syngas.

In accordance with one aspect of the invention, a process for the catalytic conversion of a hydrocarbon feedstock to syngas is provided. Conversion of the hydrocarbon is achieved by contacting a feed stream comprising the hydrocarbon feedstock and an oxygen-containing gas with a chromium-based catalyst in a reaction zone maintained at conversion-promoting conditions effective to produce an effluent stream comprising carbon monoxide and hydrogen.

In accordance with another aspect of the invention, catalyst compositions comprising chromium oxide, a rare earth metal oxide (i.e., having an atomic number of 57 through 71) and, optionally, one or more metal oxides from Group 1 of the periodic table of the elements (i.e., Li, Na, K, Rb and Cs), Ni and Co are provided. The preferred compositions do not have a perovskite structure.

Another aspect of the present invention includes methods of making, synthesizing or preparing the new chromium-rare earth based catalytic compositions. As discussed in more detail below, many of the new chromium-rare earth based catalysts exhibit high methane oxidation activities and selectivities to syngas (CO and H₂) in a millisecond contact time reactor.

The low light-off temperatures of these materials (i.e., less than 650° C.) and superior performance are indicative of the more preferred catalytic compositions. Many of the chromium-rare earth oxide catalysts show little or no carbon or coke build-up after reaction with CH₄/O₂. Trends in light-off temperature appear to correlate with the basicity or ionicity of the rare earth components, which may, in turn, relate to trends in C—H activation.

In accordance with certain embodiments of the present invention, a chromium-based composition for catalyzing the conversion of a C₁-C₅ hydrocarbon to form a product gas mixture containing CO and H₂ is provided. In some embodiments the catalyst may include an oxidatively and thermally stable porous support for a catalytically active chromium-rare earth based composition. The preferred chromium-rare earth based compositions do not have a perovskite structure, however. In certain embodiments which include a porous material, or support, the porous material may include at least one oxide or oxyhydroxide of a metal such as magnesium, silicon, titanium, tantalum, zirconium or aluminum.

In some embodiments of the catalyst compositions the chromium or chromium-containing compound comprises an atomic ratio of about 0.1-0.9 of the metal or metal ion in the catalyst composition. In some embodiments the catalyst composition initially comprises a catalyst precursor comprising a metal and a metal oxide, and after reaction in a syngas reactor, the catalyst finally comprises reduced metal and metal oxide. Some of these compositions finally comprise, after exposure to reaction conditions for a period of time, metal oxide and substantially no deposited carbon.

In accordance with yet another aspect of the present invention, processes are provided for converting a C₁-C₅ hydrocarbon to form a product gas mixture containing CO and H₂. In certain embodiments the process comprises mixing a C₁-C₅ hydrocarbon-containing feedstock and an oxygen-containing (preferably in the form of O₂) feedstock to provide a reactant gas mixture feedstock. The process includes contacting said reactant gas mixture feedstock with a catalytically effective amount of one of the above-described chromium-based catalyst compositions. During the catalyst/reactant gas contacting period, the composition and the reactant gas mixture are maintained at a temperature of about 600-1,100° C. or, preferably, about 700-1,000° C. The reactant gas feed is also maintained at a pressure of about 100-12,500 kPa, preferably about 130-10,000 kPa, and the reactant gas mixture is passed over the catalyst composition at a continuous space velocity of about 20,000 to at least about 100,000,000 NL/kg/h, preferably about 50,000-50,000,000 NL/kg/h, such that the catalyst is in contact with each passing portion of reactant gas mixture for a very short period of time that is less than 10 milliseconds. Some embodiments of the syngas manufacturing process include mixing a methane-containing gas feedstock and an O₂-containing gas feedstock to provide a reactant gas mixture having a carbon:oxygen ratio of about 1.25:1 to about 3.3:1, or about 1.3:1 to about 2.2:1, or about 1.5:1 to about 2.2:1, preferably about 2:1.

In some embodiments of the hydrocarbon conversion processes, the oxygen-containing gas also includes steam, CO₂, or both. In some embodiments the process comprises mixing a hydrocarbon feedstock and a gas comprising steam and/or CO₂ to provide a reactant gas mixture. In some embodiments the C₁-C₅ hydrocarbon comprises at least about 50% methane by volume of the reactant gas mixture, preferably at least about 75%, and more preferably at least about 80% methane by volume of the reactant gas mixture. Certain embodiments of the processes of making syngas provide for preheating the hydrocarbon feedstock and the oxygen-containing feedstock before contacting the catalyst composition. Other embodiments, features and advantages of the present invention will become apparent with reference to the following figures and description.

### BRIEF DESCRIPTION OF THE DRAWINGS

FIG. 1 is a graph showing trends in light-off temperature and basicity/ionicity of representative “support” matrix compositions.

FIG. 2 is a graph showing the results of thermal gravimetric analysis (TGA) studies of a representative rare earth oxide based chromium catalyst.

### DETAILED DESCRIPTION OF PREFERRED EMBODIMENTS

Key components of the preferred catalysts are chromium and a rare earth element (i.e., atomic number 57 through 71 of the periodic table of the elements). The catalyst composition may also contain one or more metal compounds, the metal of which is a Group 1 (i.e., Li, Na, K, Rb and Cs) element, Co or Ni. The amount of catalytic metal present in the composition may vary widely. Preferably the catalyst comprises from about 0.1 mole % to about 90 mole % (as the metal) of chromium per total moles of catalytic metal and matrix metal, and more preferably from about 10 mole % to about 70 mole %. Preferably the rare earth component comprises from about 1% to about 90%. One or more of the catalytic components may serve as a matrix material in which another catalytic metal or metal-containing compound is dispersed. A matrix is a skeletal framework of oxides and oxyhydroxides. Alternatively, or additionally, another oxidatively and thermally stable material may serve as a matrix or a support for the active catalyst composition. Suitable matrix-forming materials are alkoxides of magnesium, silicon, titanium, tantalum, zirconium or aluminum. For example, a composition containing 10% Cr, 1% Li, 27% La and α-Al₂O₃ may be used.

Test Procedure

Catalysts were evaluated in a 25 cm long quartz tube short, or millisecond, contact time reactor equipped with a co-axial, quartz thermocouple well, resulting in a 4 mm, reactor i.d. The void space within the reactor was packed with quartz chips. The catalyst bed was positioned with quartz wool at approximately mid-length in the reactor. A three point, K type, thermocouple was used with the catalyst's “hot spot”, read-out temperature reported as the run temperature. The catalyst bed was heated with a 4 inch (10.2 cm), 600 W band furnace at 90% electrical output. Mass flow controllers and meters regulated the feed composition and flow rate. Prior to start-up, the flows were checked manually with a bubble meter and then the feed composition was reconfirmed by gas chromatographic analysis. The flow rates of all the meters were safety interlocked and their measurements were checked electronically by the mass flow meters every second. All runs were performed at a CH₄:O₂ feed ratio of 2:1, safely outside of the flammable region. Specifically, the feed contained, in volume %, 30% CH₄, 15% O₂ and 55% N₂. Experiments were conducted at 5 psig (136 kPa) and a reactant gas/catalyst contact time of less than 10 milliseconds. The reactor effluent was analyzed by a gas chromatograph (g.c.) equipped with a thermal conductivity detector. The feed components (CH₄, O₂, N₂) and potential products (CO, H₂, CO₂, and H₂O) were all well resolved and reliably quantified by two chromatography columns in series consisting of 5A molecular sieve and Haysep T. Mass balances of C, H, and O all closed at 98-102%. Runs were conducted up to two operating days, each with 6 hours of steady state run time.

### EXAMPLE 1

Cr_{0.1}La_{0.9}Ox

An aqueous solution of Cr₃(OH)₂(CH₃CO₂)₇ (2.22 mL, 2.5603 M in Cr) and aqueous La(NO₃)₃ (42.78 mL, 1.1955 M) were simultaneously added to a 150 mL petri dish with gentle swirling. The entire solution was rapidly frozen with liquid nitrogen and dried as a frozen solid under vacuum for several days to produce a freeze dried powder. The freeze dried material was heated in air at 350° C. for 5 hours prior to pelletization and use. The final catalyst had a nominal metal ratio of Cr_{0.1}La_{0.9}.

### EXAMPLE 2

Cr_{0.1}Ce_{0.9}Ox

An aqueous solution of Cr₃(OH)₂(CH₃CO₂)₇ (1.375 mL, 2.560 M in Cr) and aqueous solution of Ce(NO₃)₃.6H₂O (43.625 mL, 0.7261 M) were simultaneously added to a 150 mL pyrex petri dish with gentle swirling. The entire solution was rapidly frozen with liquid nitrogen and dried as a frozen solid under vacuum for several days to produce a freeze dried powder. The freeze dried material was heated in air at 350° C. for 5 hours prior to pelletization and use. The final catalyst had a nominal metal ratio of Cr_{0.1}Ce_{0.9}.

### EXAMPLE 3

Cr_{0.1}Sm_{0.9}Ox

An aqueous solution of Cr₃(OH)₂(CH₃CO₂)₇ (0.969 mL, 2.560 M in Cr) and an aqueous solution of samarium nitrate (44.031 mL, 0.5069 M), the solution was formed using water and nitric acid to bring the final pH to 0.24 to dissolve Sm(NO₃)₃.6H₂O, were simultaneously added to a 150 mL pyrex petri dish with gentle swirling. The entire solution was rapidly frozen with liquid nitrogen and dried as a frozen solid under vacuum for several days to produce a freeze dried powder. The freeze dried material was heated in air at 350° C. for 5 hours prior to pelletization and use. The final catalyst had a nominal metal ratio of Cr_{0.1}Sm_{0.9}.

### EXAMPLE 4

10% Cr/1% Li/27% La/αAl₂O₃

An aqueous solution of LiNO₃ (1.762 g) in distilled water was added by the incipient wetness technique to an alpha-alumina support (19.723 g, calcined at 900° C. overnight before use). The solids were dried at 110° C. for two hours. An aqueous solution of La(NO₃)₃.6H₂O (22.134 g) in distilled water was added by the incipient wetness technique to the dried solids. The solids were again dried at 110° C. for two hours. An aqueous solution of Cr(NO₃)₃.9H₂O (23.087 g) in distilled water was added by the incipient wetness technique to the dried solids. Finally, the material was dried at 110° C. for two hours followed by calcination at 900° C. overnight. The final catalyst had a nominal composition of 10% Cr/1% Li/27% La/α-Al₂O₃ (wt %).

### EXAMPLE 5

2% Cr/1% Li/27% La/α-Al₂O₃

An aqueous solution of LiNO₃ (1.762 g) in distilled water was added by the incipient wetness technique to an alpha-alumina support (22.123 g, calcined at 900° C. overnight before use). The solids were dried at 110° C. for two hours. An aqueous solution of La(NO₃)₃.6H₂O (22.134 g) in distilled water was added by the incipient wetness technique to the dried solids. The solids were again dried at 110° C. for two hours. An aqueous solution of Cr(NO₃)₃.9H₂O (4.617 g) in distilled water was added by the incipient wetness technique to the dried solids. Finally, the material was dried at 110° C. for two hours followed by calcination at 900° C. overnight. The final catalyst had a nominal composition of 2% Cr/1% Li/27% La/α-Al₂O₃ (wt %).

A catalytically effective amount of the catalyst compositions of Examples 1-5 were evaluated as described in the section entitled “Test Procedure.” The results of these tests are shown in Table 1. Catalyst performance is reported at steady state and showed no evidence of catalyst deactivation after 12 hours, according to g.c. analysis.

TABLE 1
Catalyst Performance

| | | | | | GHSV | | | | |
|---|---|---|---|---|---|---|---|---|---|
| Example | Catalyst | | | Temp. | ×10⁴ | % CH₄/O₂ | % CO/H₂ | | |
| No. | Composition | V(mL) | Wt.(g) | ° C. | (NL/kg/h) | Conv. | Sel. | H₂:CO | % Coke |
| 1 | Cr_{0.1}La_{0.9}Ox | 2 | 2.1417 | 770 | 6.1 | 58/100 | 83/73 | 1.8 | 0.08 |
| 2 | Cr_{0.1}Ce_{0.9}Ox | 0.4 | 0.5972 | 860 | 3.045 | 36/100 | 49/45 | 1.8 | n.d. |
| 3 | Cr_{0.1}Sm_{0.9}Ox | 0.4 | 0.5350 | 870 | 3.045 | 48/100 | 65/66 | 2.0 | 0.17 |
| 4 | 10% Cr, 1% Li/27% La/α-Al₂O₃ | 0.9 | 1.0235 | 850 | 6.1 | 90/100 | 97/90 | 1.9 | n.d. |
| 5 | 2% Cr, 1% Li, 27% La/α-Al₂O₃ | 0.4 | 0.5327 | 830 | 3.045 | 90/100 | 96/93 | 1.9 | 2.69 |

n.d. = none detected

The conventional view is that chromium promoters or additives promote non-selective reaction pathways for alkane oxidation reactions using molecular oxygen, O₂. Therefore, the selective behavior of chromium oxide-based compositions as catalysts for converting methane and oxygen to CO and H₂ by a net partial oxidation reaction, as disclosed herein, is unexpected and even surprising. In one inventor's experience with n-butane oxidation, for example, it was observed that chromium promoters in vanadium phosphorus oxide catalysts increased catalyst activity at the expense of selectivity. In these cases the catalysts were compared at the same percent conversion of reactant. A similar trend was also noted by Oganowski, W. et al. (“Promotional Effect of Molybdenum, Chromium and Cobalt on a V—Mg—O catalyst in oxidative dehydrogenation of ethylbenzene to styrene,” Applied Catalysis A: General 136 (1996) 143-159.) At page 156 of that reference, the reaction chemistry is the oxidative dehydrogenation of ethylbenzene to styrene: “The molybdenum, chromium or cobalt doped V—Mg—O catalyst changes its activity and selectivity in the oxidative dehydrogenation of ethylbenzene. The specific activity decreases in the direction Cr,Co>Cr>Co>Mo while the selectivity increases in the direction: Cr>>Co,Cr,Co>Mo.” This suggests that Cr would not serve as a selective catalyst for a process involving C—H activation, such as CH₄ partial oxidation, and is contrary to the inventors' present findings.

Furthermore, low carbon formation is a very unusual, unexpected, and advantageous feature of many of the new chromium catalyst systems, when employed on-stream in a short contact time reactor to catalytically convert methane to syngas. The following series of Cr—Ni and rare earth promoted Cr—Ni oxide catalysts were synthesized and tested, to illustrate trends in C—H activation. Many of these catalyst formulations also demonstrate reduction of carbon formation.

### EXAMPLE 6

Ni_{0.2}Cr_{0.8}Ox (Comparative Example)

13.93 ml of Ni(NO₃)₂ of 1.068 M solution (prepared by dissolving Ni(NO₃)₂.6H₂O in water. Stoichiometry was determined by inductively coupled plasma compositional analysis (ICP) for elemental analysis was combined with 119 ml of an aqueous solution of Cr₃(OH)₂(CH₃COO)₇ (Aldrich 31,810-8) (0.5 M in Cr), prepared by diluting a 2.5603 M solution of chromium hydroxide acetate in water). The mixed solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 5 hour soak at 350° C., 5° C./min to 525° C., 525° C. soak for 1 hour; 10° C./min to room temperature. The material was sieved prior to the reactor evaluation. The Ni_{0.2}Cr_{0.8}Ox powder was evaluated as described in the section entitled “Test Procedure.”

### EXAMPLE 7

Ni_{0.1}Cr_{0.9}Ox (Comparative Example)

27.149 ml of an aqueous solution of Cr₃(OH)₂(CH₃COO)₇ (Aldrich, 31,820-8) (1.6575 M in Cr) and 4.682 ml of 1.068 M Ni (NO₃)₂ solution (prepared by dissolving Ni(NO₃)₂.6H₂O in water (stoichiometry of the composition determined by ICP elemental analysis) were simultaneously added to a 150 ml pyrex petri dish with gentle swirling. The entire solution was rapidly frozen with liquid nitrogen and dried as a frozen solid under vacuum for several days in a Virtis 25EL “Freezemobile” equipped with a Unitop 800 L unit (with refrigerated shelves) to produce a freeze dried powder. The freeze dried material was heated or calcined in air at 350° C. for 5 hrs prior to pelletization and use in a microreactor, as described in “Test Procedure.”

### EXAMPLE 8

Ni_{0.01}Cr_{0.90}Ox

An identical procedure was used (as described in Example 7), except that 29.864 ml of the chromium hydroxide acetate solution and 0.468 ml of the nickel nitrate solution were used.

### EXAMPLE 9

Y_{0.1}Cr_{0.7}Ni_{0.2}Ox

An identical procedure as described in Example 7 was used. 8.554 ml of 0.9352 M yttrium nitrate solution (prepared by dissolving Y(NO₃)₃ hydrate (Alfa 12898) in water) was combined with 33.786 ml of an aqueous solution of Cr₃(OH)₂(CH₃COO)₇ (Aldrich, 31,820-8) (1.6575 M in Cr), and 14.981 ml of Ni (NO₃)₂ of 1.068 M solution (prepared by dissolving Ni(NO₃)₂.6H₂O in water).

### EXAMPLE 10

La_{0.1}Cr_{0.7}Ni_{0.2}Ox

An identical procedure to that described in Example 7 was used, except that 6.692 ml of 1.1955 M lanthanum nitrate ((La(NO₃)₃ aqueous solution (prepared by dissolving 503.02 g of La(NO₃).xH₂O (La content 33.0 wt %; Aldrich 23,855-4) in sufficient water to make a 1.1955 M solution) was combined with 33.786 ml of an aqueous solution of Cr₃(OH)₂(CH₃COO)₇ (Aldrich, 31,810-8) (1.6575 M in Cr), and 14.981 ml of 1.068 M Ni(NO₃)₂ prepared by dissolving Ni(NO₃)₂.6H₂O in sufficient water to make a 1.068 M solution). The molarity of the solutions were determined by ICP elemental analysis.

### EXAMPLE 11

Ce_{0.1}Cr_{0.7}Ni_{0.2}Ox

An identical procedure to that described in Example 7 was used, except that 8.00 ml of 1.00 M cerium nitrate ((Ce(NO₃)₃ aqueous solution (prepared by dissolving 503.02 g of Ce(NO₃).6H₂O (Alfa 11329) in sufficient water to make a 1.00 M solution) was combined with 33.786 ml of an aqueous solution of Cr₃(OH)₂(CH₃COO)₇ (Aldrich, 31,820-8) (1.6575 M in Cr), and 14.981 ml of 1.068 M Ni(NO₃)₂ (prepared by dissolving Ni(NO₃)₂.6H₂O in sufficient water to make a 1.068 M solution). Molarity was determined by ICP elemental analysis).

TABLE 2
Ni-Cr and Rare Earth Promoted Ni-Cr Catalysts

| Example | |
|---|---|
| No. | Composition* |
| 6 | Ni_{0.2}Cr_{0.8}Ox |
| 7 | Ni_{0.1}Cr_{0.9}Ox |
| 8 | Ni_{0.01}Cr_{0.99}Ox |
| 9 | Y_{0.1}Cr_{0.7}Ni_{0.2}Ox |
| 10 | La_{0.1}Cr_{0.7}Ni_{0.2}Ox |
| 11 | Ce_{0.1}Cr_{0.7}Ni_{0.2}Ox |

*Atomic ratios metals content

TABLE 3
Performance of Ni—Cr and Rare Earth-Ni—Cr Catalysts

| | | | | GHSV | | | | | | |
|---|---|---|---|---|---|---|---|---|---|---|
| Ex. | Vol. | Wt. | Temp. | ×10⁴ | | | % CO | % H₂ | H₂:CO | |
| No. | (mL) | (g) | (° C.) | L/kg/h | % CH₄ | % O₂ | Conv. | Conv. | Sel. | Coke Sel. |
| 6 | 2.0 | 2.6096 | 686 | 6.1 | 94 | 100 | 97 | 98 | 2.02 | 12.8 |
| | | | 787* | 4.6 | 91 | 100 | 97 | 98 | 2.02 | 12.8 |
| | | | 571* | 7.6 | 93 | 100 | 99 | 99 | 2.00 | 12.8 |
| | | | 599* | 12.2 | 91 | 100 | 98 | 98 | 2.00 | 12.8 |
| | | | 571* | 15.2 | 90 | 100 | 98 | 98 | 2.00 | 23.8** |
| 7 | 2.0 | 2.2551 | 746 | 6.1 | 90 | 100 | 96 | 95 | 1.98 | 0.83 |
| 8 | 2.0 | 2.1817 | 804 | 6.1 | 80 | 100 | 91 | 87 | 1.91 | 0.43 |
| 9 | 2.0 | 2.0049 | 748 | 6.1 | 95 | 100 | 97 | 97 | 2.00 | 2.62 |
| 10 | 2.0 | 2.1250 | 758 | 6.1 | 96 | 100 | 98 | 97 | 1.98 | 1.93 |
| 11 | 2.0 | 2.4859 | 753 | 6.1 | 96 | 100 | 98 | 97 | 1.98 | 1.67 |

Compositions were evaluated for 6 hrs., except where noted otherwise.
*Feed composition 90% CH₄, 30% O₂ and 10% N₂
**Evaluated for 25 hrs.

From Tables 2 and 3 it can be seen that carbon buildup is suppressed with use of the M_{0.1}Cr_{0.7}Ni_{0.2} series catalysts (where M is a rare earth ion), compared to the greater amount of coke deposition obtained with the Ni_{0.2}Cr_{0.8}Ox catalyst composition

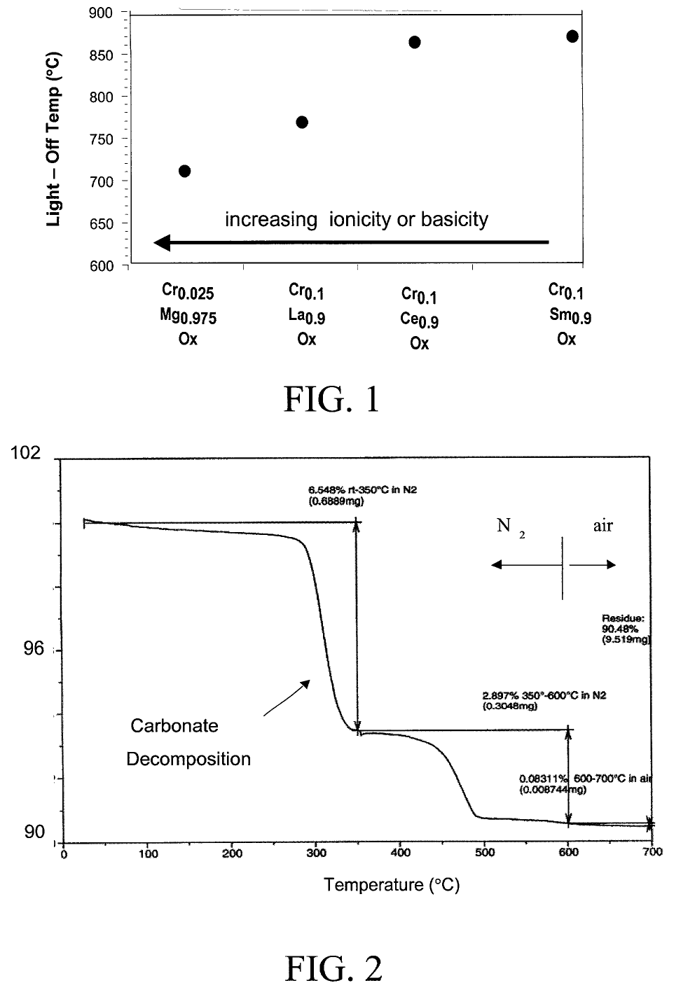

FIG. 1 is a graph showing trends in light-off temperature and basicity/ionicity of representative “support” matrix compositions (i.e., Cr_{0.1}La_{0.9}Ox, Cr_{0.1}Ce_{0.9}Ox, Cr_{0.1}Sm_{0.9}Ox, and Cr_{0.025}Mg_{0.975}Ox from Examples 1, 2, 3 and 22, respectively). The predicted ionicity or basicity of the compositions increases from right to left along the x-axis of the graph. These systems were chosen for their thermal stability. In addition, rare earth oxide base catalysts have been reported for methane coupling-type reactions. The basicity of these rare earth oxide systems may facilitate C—H activation. Trends in light-off temperature, or ignition temperature, suggest that this may be the case. A lanthanum chromium oxide compound (comprised of La₂Cr₂O₆+Cr₂O₃ in powder X-ray diffraction studies) possesses the lowest light-off or ignition temperature. A plot of the light-off temperature versus the expected basicity or ionicity of the rare earth component shows a correlation which suggests C—H activation may be related to this property.

Thermogravimetric analysis (TGA) studies also indicate low carbon deposition for the rare earth oxide based chromium catalysts, as shown in FIG. 2 for La_{0.1}Cr_{0.9}Ox (Cr₂O₃+La₂Cr₂O₆ by X-ray diffraction), prepared similarly to the freeze-drying methods described above. In FIG. 2, the arrow at about 300° C. indicates a temperature region where the catalyst undergoes carbonate decomposition and appreciable weight loss occurs. Carbon deposition, as indicated by the weight loss at about rt-350° C. in N₂ is 6.548% (0.6889 mg). The weight loss from about 350-600° C. is 2.897% (0.3048 mg), and from about 600-700° C. is 0.08311% (0.008744 mg). TGA analysis of weight loss in air (>600° C.) indicates <<1 wt % carbon deposition for these catalyst systems after eight hours on stream (i.e., <0.07 wt % upon oxidation in air from 600-700° C. for La_{0.1}Cr_{0.9}Ox).

With catalytic use the oxides of Co and Ni tend to sinter, forming metal plus ceramic oxide in situ, which contributes to coking, decreasing catalyst performance and catalyst life. This behavior is more problematic at higher operating temperatures. In light of this problem, it is particularly interesting that the new rare earth-containing Ni Cr compounds (e.g., the A_{0.1}Cr_{0.7}Ni_{0.2}Ox series of Examples 9-11), exhibit suppression of coke formation. This quality was present even though the CH₄/O₂ conversion and product selectivity activities demonstrated in these tests appeared to be comparable to that of other Cr-containing compositions, as shown in Table 3. The percent coking with the catalyst of Example 6, evaluated after 6 hrs. on stream, was 12.8%. The same composition evaluated at 25 hrs. experienced 23.8% coke formation. By comparison, the rare earth compounds showed markedly less carbon build-up during a 6 hr evaluation, indicating the desirable longer life of these catalyst compositions. Although not wishing to be limited to any one theory, it is thought that the action of the rare earth oxide may be one of moderating (i.e., lowering) the surface acidity of the oxide, which suppresses some of the acid catalyzed carbon forming reactions.

A series of rare earth-chromium oxide catalysts were prepared and evaluated in the reduced scale reactor, as described in “Test Procedure.”

### EXAMPLE 12

Cr_{0.1}La_{0.9}Ox

2.22 ml of an aqueous solution of Cr₃(OH)₂(CH₃COO)₇ (Aldrich, 31,810-8) (2.5603 M in Cr), 42.78 ml of 1.1955 M aqueous La(NO₃)₃ (33 wt % as La in La(NO₃)₃xH₂O, Aldrich 23, 855-4) were simultaneously added to a 150 ml pyrex petri dish with gentle swirling. The entire solution was rapidly frozen with liquid nitrogen and dried as a frozen solid under vacuum for several days in a Virtis 25EL “Freezemobile” equipped with a Unitop 800 L unit (with refrigerated shelves) to produce a freeze dried powder. The freeze dried material was heated or calcined in air at 350° C. for 5 hrs prior to pelletization and use in a microreactor.

### EXAMPLE 13

Cr_{0.1}Ce_{0.9}Ox

1.375 ml of an aqueous solution of Cr₃(OH)₂(CH₃COO)₇ (Aldrich, 31,810-8) (2.560 M in Cr) and 43.625 ml of 0.7261 M aqueous Ce(NO₃)₃.6H₂O (Alfa, 11330) were simultaneously added to a 150 ml pyrex petri dish with gentle swirling. The entire solution was rapidly frozen with liquid nitrogen and dried as a frozen solid under vacuum for several days in a Virtis 25EL “Freezemobile” equipped with a Unitop 800 L unit (with refrigerated shelves) to produce a freeze dried powder. The freeze dried material was heated (calcined) in air at 350° C. for 5 hrs prior to pelletization and use in a microreactor.

### EXAMPLE 14

Cr_{0.1}Sm_{0.9}Ox

0.969 ml of an aqueous solution of Cr₃(OH)₂(CH₃COO)₇ (Aldrich, 31,810-8) (2.560 M in Cr) and 44.031 ml of 0.5069 M aqueous solution of samarium nitrate (solution was formed using water and nitric acid to bring final pH=0.24 to dissolve Sm(NO₃)₃.6H₂O (Alfa 12906)) were simultaneously added to a 150 ml pyrex petri dish with gentle swirling. The entire solution was rapidly frozen with liquid nitrogen and dried as a frozen solid under vacuum for several days in a Virtis 25EL “Freezemobile” equipped with a Unitop 800 L unit (with refrigerated shelves) to produce a freeze dried powder. The freeze dried material was heated or calcined in air at 350° C. for 5 hrs prior to pelletization and use in a microreactor.

TABLE 4
Cr-Rare Earth Ox Powder Catalysts

| Example | |
|---|---|
| No. | Composition* |
| 12 | Cr_{0.1}La₀₉Oₓ |
| 13 | Cr_{0.1}Ce_{0.9}Oₓ |
| 14 | Cr_{0.1}Sm_{0.9}Oₓ |

*Expressed as the atomic ratios of the metals content

TABLE 5
Performance of Cr-Rare Earth Ox Catalysts

| | | | | GHSV | | | | | |
|---|---|---|---|---|---|---|---|---|---|
| Example | Vol. | Wt. | Temp | ×10⁴ | % CH₄ | % O₂ | % CO | % H₂ | |
| No. | (mL) | (g) | (° C.) | (NL/kg/h) | Conv. | Conv. | Sel. | Sel. | H₂:CO |
| 12 | 2.0 | 2.1417 | 770 | 6.1 | 58 | 100 | 83 | 73 | 1.76 |
| 13 | 0.4 | 0.5972 | 860 | 3.0 | 36 | 100 | 49 | 45 | 1.84 |
| 14 | 0.4 | 0.5350 | 870 | 3.0 | 48 | 100 | 65 | 66 | 2.03 |

### EXAMPLE 15

Co_{0.1}Cr_{0.8}La_{0.1}Ox

6.692 ml of 1.1955 M lanthanum nitrate ((La(NO₃)₃ aqueous solution (prepared by dissolving 503.02 g of La(NO₃).xH₂O (La content 33.0 wt %; Aldrich 23,855-4) in sufficient water to make a 1.1955 M solution) was combined with 38.612 ml of an aqueous solution of Cr₃(OH)₂(CH₃COO)₇ (Aldrich, 31,810-8) (1.6575 M in Cr), and 7.39 ml of 1.0826 M Co(NO₃)₂ solution, (prepared by dissolving Co(NO₃)₂.6H₂O (Alfa 11341) in water). The solution was freeze-dried and prepared for testing as previously described.

TABLE 6
Performance of Co_{0.1} Cr_{0.8}La_{0.1} Ox

| | | | | GHSV | | | | | | |
|---|---|---|---|---|---|---|---|---|---|---|
| Example | Vol. | Wt. | Temp | ×10⁴ | % CH₄ | % O₂ | % CO | % H₂ | | |
| No. | (mL) | (g) | (° C.) | (NL/kg/h) | Conv. | Conv. | Sel. | Sel. | H₂:CO | % Coke |
| 15 | 2.0 | 2.0155 | 660 | 6.1 | 89 | 100 | 96 | 97 | 2.02 | |
| | | | 624 | 7.6* | 91 | 100 | 98 | 98 | 2.00 | |
| | | | 533 | 12.2 | 89 | 100 | 98 | 98 | 2.00 | |
| | | | 492 | 15.2* | 88 | 100 | 98 | 98 | 2.00 | |

*O₂ feed

As demonstrated by the performance characteristics shown in Table 6, the chromium-lanthanum-cobalt containing catalyst surprisingly proved to be selective for a process involving C—H activation, such as CH₄ partial oxidation. Once again, this observation contrasts with the conventional views of catalysts containing chromium promoters or additives, which have in the past generally been considered to be useful only for promoting the non-selective reaction pathways for alkane oxidation reactions using molecular oxygen (O₂).

Similar to the coke-suppressing effect demonstrated above by Cr—Ni—La Ox compositions, the addition of a rare earth oxide to Cr—Co also reduced carbon deposition on the catalyst after use in the reduced scale reactor. The catalyst of Example 15 (Co_{0.1}Cr_{0.8}La_{0.1}Ox) had 0.61% carbon formation after 6 hrs on-stream with an O₂ feed, according to the “Test Procedure.” By comparison, a composition of Co_{0.1}Cr_{0.9}Ox demonstrated 2.74% carbon under similar conditions.

A series of chromium-lanthanum oxide catalysts were also prepared and evaluated, as follows:

### EXAMPLE 16

La₂O₃

100 ml of a Lanthanum Nitrate solution (1.1955 M, prepared by dissolving 414.13 g of La(NO₃).6H₂O, Alfa 12915 in sufficient water to make a 1.1955 M solution) was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 350° C. for 5 hours, 5° C./min to 525° C., 525° C. 1 hour; 10° C./min to room temperature. The material was pelletized and sieved prior to the reactor evaluation as described above.

### EXAMPLE 17

Cr_{0.1}La_{0.9}Ox

95.068 ml of a Lanthanum Nitrate solution (1.1955 M, prepared by dissolving 414.13 g of La(NO₃).6H₂O, Alfa 12915 in sufficient water to make a 1.1955 M solution) was simultaneously added to a 4.932 ml of an aqueous solution of chromium hydroxide acetate (Aldrich, 31,810-8) (2.5603 M in Cr) solution (molarity determined by ICP analysis). The solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 350° C. for 5 hours, 5° C./min to 525° C., 525° C. 1 hour; 10° C./min to room temperature. The material was pelletized and sieved prior to the reactor evaluation as described above.

### EXAMPLE 18

Cr_{0.25}La_{0.75}Ox

86.532 ml of a lanthanum nitrate solution (1.1955 M, prepared by dissolving 414.13 g of La(NO₃).6H₂O, Alfa 12915 in sufficient water to make a 1.1955 M solution) was simultaneously added to a 13.468 ml of an aqueous solution of chromium hydroxide acetate (Aldrich, 31,810-8) (2.5603 M in Cr) solution (molarity determined by ICP analysis). The solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 350° C. for 5 hours, 5° C./min to 525° C., 525° C. 1 hour; 10° C./min to room temperature. The material was pelletized and sieved prior to the reactor evaluation as described above.

### EXAMPLE 19

Cr_{0.5}La_{0.5}Ox

68.169 ml of a lanthanum nitrate solution (1.1955 M, prepared by dissolving 414.13 g of La(NO₃).6H₂O, Alfa 12915 in sufficient water to make a 1.1955 M solution) was simultaneously added to a 31.831 ml of a chromium hydroxide acetate solution (aqueous, 2.5603 M, determined by ICP analysis, chromium hydroxide acetate obtained from Aldrich, 31,810-8). The solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 350° C. for 5 hours, 5° C./min to 525° C., 525° C. 1 hour; 10° C./min to room temperature. The material was pelletized and sieved prior to the reactor evaluation as described above.

### EXAMPLE 20

Cr_{0.75}La_{0.25}Ox

41.653 ml of a lanthanum nitrate solution (1.1955 M, prepared by dissolving 414.13 g of La(NO₃).6H₂O, Alfa 12915 in sufficient water to make a 1.1955 M solution) was simultaneously added to a 58.347 ml of an aqueous solution of chromium hydroxide acetate (Aldrich, 31,810-8) (2.5603 M in Cr) solution (molarity determined by ICP analysis). The solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 350° C. for 5 hours, 5° C./min to 525° C., 525° C. 1 hour; 10° C./min to room temperature. The material was pelletized and sieved prior to the reactor evaluation as described above.

### EXAMPLE 21

Cr_{0.9}La_{0.1}Ox

19.222 ml of a Lanthanum Nitrate solution (1.1955 M, prepared by dissolving 414.13 g of La(NO₃).6H₂O (Alfa 12915) in sufficient water to make a 1.1955 M solution) was simultaneously added to 80.778 ml of an aqueous solution of chromium hydroxide acetate (Aldrich, 31,810-8) (2.5603 M in Cr) (molarity determined by ICP analysis). The solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 350° C. for 5 hours, 5° C./min to 525° C., 525° C. 1 hour; 10° C./min to room temperature. The material was pelletized and sieved prior to the reactor evaluation as described above.

TABLE 7
La-Cr Ox Catalysts

| Example | |
|---|---|
| No. | Composition* |
| 16 | La₂O₃ |
| 17 | Cr_{0.1}La_{0.9}Ox |
| 18 | Cr_{0.25}La_{0.75}Ox |
| 19 | Cr_{0.5}La_{0.5}Ox |
| 20 | Cr_{0.75}La_{0.25}Ox |
| 21 | Cr_{0.9}La_{0.1}Ox |

TABLE 8
Performance of La-Cr Series Catalysts

| | | | | GHSV | | | | | |
|---|---|---|---|---|---|---|---|---|---|
| Example | Vol. | Wt. | Temp | × 10⁴ | % CH₄ | % O₂ | % CO | % H₂ | |
| No. | (mL) | (g) | (° C.) | (NL/kg/h) | Conv. | Conv. | Sel. | Sel. | H₂:CO |
| 16 | 2.0 | 2.3996 | 860 | 6.1 | 55 | 100 | 70 | 55 | 1.57 |
| 17 | 2.0 | 2.2106 | 830 | 6.1 | 43 | 100 | 63 | 46 | 1.46 |
| 18 | 2.0 | 1.5846 | 955 | 6.1 | 51 | 100 | 67 | 52 | 1.55 |
| 19 | 2.0 | 2.2184 | 746 | 6.1 | 59 | 100 | 85 | 72 | 1.69 |
| 20 | 2.0 | 1.9359 | 834 | 6.1 | 69 | 100 | 87 | 78 | 1.79 |
| 21 | 2.0 | 1.9517 | 873 | 6.1 | 69 | 100 | 90 | 80 | 1.78 |

### EXAMPLE 22

Cr_{0.025}Mg_{0.975}Ox (Comparative Example)

A magnesium methoxide solution (68.767 mL, 0.3495 M) diluted with 50 volume % ethanol punctilious) was added to a 150 mL petri dish with gentle swirling under an inert N₂ atmosphere. In a subsequent addition, 1.233 mL of an aqueous solution of Cr₃(OH)₂(CH₃CO₂)₇ (0.5 M in Cr) was introduced to the petri dish while it was gently swirled. Following the addition of the aqueous solutions, a gel point was realized and a homogeneous gel formed which was nearly white in color. The gel was allowed to age 8 days in air and then dried under vacuum at 120° C. prior to use. The final xerogel had a nominal metal ratio of Cr_{0.025}Mg_{0.975}.

TABLE 9
Performance of Cr_{0.025}Mg_{0.975}Ox

| | | | | | GHSV | | | | |
|---|---|---|---|---|---|---|---|---|---|
| Example | Catalyst | | | Temp. | × 10⁴ | % CH₄/O₂ | % CO/H₂ | | |
| No. | Composition (mole %) | V(mL) | Wt. (g) | ° C. | (NL/kg/h) | Conv. | Sel. | H₂:CO % Coke | |
| 22 | Cr_{0.025}Mg_{0.975}Ox | 2 | 0.9024 | 710 | 6.1 | 45/100 | 74/48 | 1.3 | 2.99 |

In FIG. 1 the predicted greater ionicity or basicity of Cr_{0.025}Mg_{0.975}Ox, compared to that of Cr_{0.1}La_{0.9}Ox, Cr_{0.1}Ce_{0.9}Ox and Cr_{0.1}Sm_{0.9}Ox, is shown, together with the corresponding light-off temperatures when tested according to the “Test Procedure.”

Although the preferred technique for preparing the representative Cr-rare earth based catalyst compositions involved freeze drying an aqueous solution, a variety of other well-known techniques such as impregnation, xerogel, aerogel or sol gel formation, spray drying or spray roasting could also be used with success. In addition to catalyst powders and pellets, extrudates and monoliths may also be used as supports, provided that they have sufficient porosity for reactor use, as described under “Test Procedure.” The supports used with some of the catalyst compositions may be in the form of monolithic supports or other configurations having longitudinal channels or passageways permitting high space velocities with a minimal pressure drop. Such catalyst forming techniques and configurations are known and have been described in, for example, Structured Catalysts and Reactors, A. Cybulski and J. A. Moulijn (Eds.), Marcel Dekker, Inc., 1998, p. 599-615 (Ch. 21, X. Xu and J. A. Moulijn, “Transformation of a Structured Carrier into Structured Catalyst”).

Process of Producing Syngas

Any suitable reaction regime is applied in order to contact the reactants with the catalyst. One suitable regime is a fixed bed reaction regime, in which the catalyst is retained within a reaction zone in a fixed arrangement. Supported or self-supporting catalysts may be employed in the fixed bed regime, retained using fixed bed reaction techniques well known in the art. Preferably a short or millisecond contact time reactor is employed. Several schemes for carrying out catalytic partial oxidation (CPOX) of hydrocarbons in a short contact time reactor have been described in the literature. For example, L. D. Schmidt and his colleagues at the University of Minnesota describe a millisecond contact time reactor in U.S. Pat. No. 5,648,582 and in J. Catalysis 138, 267-282 (1992) for use in the production of synthesis gas by direct oxidation of methane over a catalyst such as platinum or rhodium. A general description of major considerations involved in operating a reactor using millisecond contact times is given in U.S. Pat. No. 5,654,491. The disclosures of the above-mentioned references are incorporated herein by reference.

Accordingly, a feed stream comprising a hydrocarbon feedstock and an oxygen-containing gas is contacted with one of the above-described chromium-based catalysts in a reaction zone maintained at conversion-promoting conditions effective to produce an effluent stream comprising carbon monoxide and hydrogen. The hydrocarbon feedstock may be any gaseous hydrocarbon having a low boiling point, such as methane, natural gas, associated gas, or other sources of light hydrocarbons having from 1 to 5 carbon atoms. The hydrocarbon feedstock may be a gas arising from naturally occurring reserves of methane which contain carbon dioxide. Preferably, the feed comprises at least 50% by volume methane, more preferably at least 75% by volume, and most preferably at least 80% by volume methane.

The hydrocarbon feedstock is contacted with the catalyst as a gaseous phase mixture with an oxygen-containing gas, preferably pure oxygen. The oxygen-containing gas may also comprise steam and/or CO₂ in addition to oxygen. Alternatively, the hydrocarbon feedstock is contacted with the catalyst as a mixture with a gas comprising steam and/or CO₂. Preferably, the methane-containing feed and the oxygen-containing gas are mixed in such amounts to give a carbon (i.e., carbon in methane) to oxygen (i.e., oxygen) ratio from about 1.25:1 to about 3.3:1, more preferably, from about 1.3:1 to about 2.2:1, and most preferably from about 1.5:1 to about 2.2:1, especially the stoichiometric ratio of 2:1.

The process is operated at atmospheric or superatmospheric pressures, the latter being preferred. The pressures may be from about 100 kPa to about 12,500 kPa, preferably from about 130 kPa to about 10,000 kPa. The process of the present invention may be operated at temperatures of from about 600° C. to about 1,100° C., preferably from about 700° C. to about 1,000° C. The hydrocarbon feedstock and the oxygen-containing gas are preferably pre-heated before contact with the catalyst. The hydrocarbon feedstock and the oxygen-containing gas are passed over the catalyst at any of a variety of space velocities. Gas hourly space velocities (GHSV) for the process, stated as normal liters of gas per kilogram of catalyst per hour, are from about 20,000 to at least about 100,000,000 NL/kg/h, preferably from about 50,000 to about 50,000,000 NL/kg/h. Preferably the catalyst is employed in a millisecond contact time reactor for syngas production. The process preferably includes maintaining a catalyst residence time of no more than 10 milliseconds for the reactant gas mixture. Residence time is the inverse of the space velocity, and high space velocity equates to low residence time on the catalyst. The effluent stream of product gases, including CO and H₂, emerges from the reactor. And, if desired, may be routed directly into a variety of applications. One such application is for producing higher molecular weight hydrocarbon components using Fisher-Tropsch technology.

Although not wishing to be bound by any particular theory, the inventors believe that the primary reaction catalyzed by the preferred catalysts described herein is the partial oxidation reaction of Equation 2, described above in the background of the invention. Additionally, other chemical reactions may also occur to a lesser extent, catalyzed by the same catalyst composition to yield a net partial oxidation reaction. For example, in the course of syngas generation, intermediates such as CO₂+H₂O may occur as a result of the oxidation of methane, followed by a reforming step to produce CO and H₂. Also, particularly in the presence of carbon dioxide-containing feedstock or CO₂ intermediate, the reaction

CH₄+CO₂→2CO+2H₂ (3)

may also occur during the production of syngas. Accordingly, the term “catalytic partial oxidation” when used in the context of the present syngas production method, in addition to its usual meaning, can also refer to a net catalytic partial oxidation process, in which a light hydrocarbon, such as methane, and O₂ are supplied as reactants and the resulting product stream is predominantly the partial oxidation products CO and H₂, in a molar ratio of approximately 2:1, rather than the complete oxidation products CO₂ and H₂O.

While the preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims. The disclosures of U.S. Provisional Patent Application Nos. 60/183,575 and 60/183,423, and all patents and publications cited herein are incorporated by reference.

What is claimed is:

1. A chromium-rare earth based composition for catalyzing the conversion of a C₁-C₅ hydrocarbon to form a product gas mixture containing CO and H₂, comprising the general composition Cr_{w}AₓB_{y}C_{Z} Oxide wherein
A is a rare earth element chosen from the group consisting of La, Ce, Pr, Nd, Sm, Eu, Gd, Tb, Dy, Ho, Er, Tm, Yb and Lu;
B is an optional metal, which if present, is chosen from the group consisting of Ni and Co;
C is an optional metal, which if present, is chosen from the group consisting of Li, Na, K, Rb and Cs; and
w, x, y, z are atomic ratios wherein w+x+y+z=1, w is about 0.01-0.99, x is about 0.01-0.99, y, if applicable, is about 0.01-0.99 and z, if applicable, is about 0.01-0.99, said composition comprising a structure other than a perovskite structure.

2. The composition of claim 1 wherein A is chosen from the group consisting of lanthanum, cerium, samarium and yttrium.

3. The composition of claim 2 wherein
w is about 0.8-0.99,
B is Ni, and
z is about 0.8-0.99.

4. The composition of claim 2 wherein
w is about 0.7,
A is chosen from the group consisting of Y, La and Ce,
x is about 0.1,
B is Ni, and
y is about 0.2.

5. The composition of claim 2 wherein
w is about 0.8,
A is La,
y is about 0.1,
B is Co, and
z is about 0.1.

6. A catalyst for catalyzing the conversion of a C₁-C₅ hydrocarbon to form a product gas mixture containing CO and H₂, said catalyst comprising, after on-stream use in a syngas production reactor for at least 6 hrs, reduced metal and/or metal oxide and no more than about 3 wt % carbon deposit.

7. A supported catalyst for catalyzing the conversion of a C₁-C₅ hydrocarbon to form a product gas mixture containing CO and H₂, comprising:
catalytically active material having the general composition Cr_{w}AₓB_{y}C_{z} oxide wherein
A is a rare earth element chosen from the group consisting of La, Ce, Pr, Nd, Sm, Eu, Gd, Tb, Dy, Ho, Er, Tm, Yb and Lu;
B is an optional metal, which if present, is chosen from the group consisting of Ni and Co;
C is an optional metal, which if present, is chosen from the group consisting of Li, Na, K, Rb and Cs; and
w, x, y, z are atomic ratios wherein w+x+y+z=1, w=0.1-0.9, x=0.1-0.9, y, if applicable, =0.1-0.9 and z, if applicable, =0.1-0.9, said composition comprising a structure other than a perovskite structure; and
a porous support comprising at least one oxide or oxyhydroxide of a metal chosen from the group consisting of magnesium, silicon, titanium, tantalum, zirconium and aluminum, said catalytically active material disposed on said support.

8. The composition of claim 1 comprising the general composition A_{0.1}Cr_{0.8}Co_{0.1}Ox expressed as atomic ratios.

9. A method of making a coking resistant catalyst for catalyzing the conversion of a C₁-C₅ hydrocarbon to synthesis gas, the method comprising:
mixing together
about 0.01-0.99 mole % chromium-containing compound per total moles of metal in said catalyst,
about 0.01-0.99 mole % rare earth-containing compound, and
forming said combination into a porous solid.

10. The method of claim 9 further including adding about 0.01-0.99 mole % Ni-containing compound or Co-containing compound to said catalyst.

11. The method of claim 9 further including adding about 0.01-0.99 mole % at least one metal-containing compound, the metal component of which is chosen from the group consisting of Li, Na, K, Rb and Cs to said catalyst.

12. The method of claim 9 further including calcining said solid.

13. The process of claim 9 wherein said step of forming comprises freeze-drying said intermediate composition.

14. The product of the method of claim 9.

15. A process for converting a C₁-C₅ hydrocarbon to a product gas mixture containing CO and H₂, the process comprising
mixing a C₁-C₅ hydrocarbon-containing feedstock and an O₂-containing feedstock to provide a reactant gas mixture feedstock;
in the reaction zone of a short contact time reactor, contacting said reactant gas mixture feedstock with a catalytically effective amount of a catalyst comprising a porous chromium-rare earth based composition comprising the general composition Cr_{w}AₓB_{y}C_{z} oxide wherein
A is a rare earth element chosen from the group consisting of La, Ce, Pr, Nd, Sm, Eu, Gd, Th, Dy, Ho, Er, Tm, Yb and Lu;
B is an optional metal, which if present, is chosen from the group consisting of Ni and Co;
C is an optional metal, which if present, is chosen from the group consisting of Li, Na, K, Rb and Cs; and
w, x, y, z are atomic ratios wherein w+x+y+z=1, w is about 0.01-0.99, x is about 0.01-0.99, y, if applicable, is about 0.01-0.99 and z, if applicable, is about 0.01-0.99, said composition comprising a structure other than a perovskite structure; and
during said contacting, maintaining catalytic partial oxidation promoting conditions of temperature, pressure, space velocity and feed composition.

16. The process of claim 15 wherein said step of maintaining catalytic partial oxidation promoting conditions comprises maintaining said reaction zone at a temperature of about 600-1,100° C.

17. The process of claim 16 wherein said step of maintaining catalytic partial oxidation promoting conditions comprises maintaining a temperature of about 700-1,000° C.

18. The process of claim 15 wherein said step of maintaining catalytic partial oxidation promoting conditions comprises maintaining a reactant gas pressure of about 100-12,500 kPa.

19. The process of claim 15 wherein said step of maintaining catalytic partial oxidation promoting conditions comprises maintaining a pressure of about 130-10,000 kPa.

20. The process of claim 15 wherein said step of maintaining catalytic partial oxidation promoting conditions comprises passing said reactant gas mixture over said composition at a continuous space velocity of about 20,000 to at least about 100,000,000 NL/kg/h.

21. The process of claim 20 wherein said step of passing said reactant gas mixture over said catalyst comprises passing said mixture at a continuous space velocity of about 50,000 to about 50,000,000 NL/kg/h.

22. The process of claim 15 wherein said step of maintaining catalytic partial oxidation promoting conditions comprises maintaining a reactant gas/catalyst contact time of no more than about 10 milliseconds.

23. The process of claim 15 further comprising mixing a methane-containing gas feedstock and an O₂-containing gas feedstock to provide a reactant gas mixture having a carbon:oxygen ratio of about 1.25:1 to about 3.3:1.

24. The process of claim 23 wherein said mixing provides a reactant gas mixture having a carbon:oxygen ratio of about 1.3:1 to about 2.2:1.

25. The process of claim 24 wherein said mixing provides a reactant gas mixture having a carbon:oxygen ratio of about 1.5:1 to about 2.2:1.

26. The process of claim 25 wherein said mixing provides a reactant gas mixture having a carbon:oxygen ratio of about 2:1.

27. The process of claim 15 wherein said O₂-containing gas further comprises steam and/or CO₂.

28. The process of claim 15 wherein said C₁-C₅ hydrocarbon comprises at least about 50% methane by volume.

29. The process of claim 28 wherein said C₁-C₅ hydrocarbon comprises at least about 75% methane by volume.

30. The process of claim 29 wherein said C₁-C₅ hydrocarbon comprises at least about 80% methane by volume.

31. The process of claim 15 further comprising preheating said hydrocarbon feedstock and said O₂-containing feedstock before contacting said catalyst.

32. The process of claim 15 further comprising retaining said catalyst in a fixed bed reaction zone.

33. A process for converting a C₁-C₅ hydrocarbon comprising at least about 80 vol % methane to a product gas mixture comprising CO and H₂, the process comprising:
mixing a methane-containing gaseous feedstock and an oxygen-containing gaseous feedstock to provide a reactant gas mixture feedstock having a carbon:oxygen ratio of about 1.25:1 to about 3.3:1;
preheating said gaseous feedstocks;
contacting said reactant gas mixture feedstock with a catalytically effective amount of a porous chromium-rare earth based catalyst comprising the general composition Cr_{w}AₓB_{y}C_{z} oxide wherein
A is a rare earth element chosen from the group consisting of La, Ce, Pr, Nd, Sm, Eu, Gd, Tb, Dy, Ho, Er, Tm, Yb and Lu;
B is an optional metal, which if present, is chosen from the group consisting of Ni and Co;
C is an optional metal, which if present, is chosen from the group consisting of Li, Na, K, Rb and Cs; and
w, x, y, z are atomic ratios wherein w+x+y+z=1, w is about 0.01-0.99, x is about 0.01-0.99, y, if applicable, is about 0.01-0.99 and z, if applicable, is about 0.01-0.99, said composition comprising a structure other than a perovskite structure;
during said contacting, maintaining said composition and said reactant gas mixture at a temperature of about 600-1,100° C.;
during said contacting, maintaining said composition and said reactant gas mixture at a pressure of about 100-12,500 kPa; and
passing said reactant gas mixture over said composition at a continuous space velocity of about 20,000 to 100,000,000 NL/kg/h, such that said reactant gas mixture contacts said catalyst for no more than 10 milliseconds.
